(19) United States
(12) Patent Application Publication
(10) Pub. No.: US 2008/0314654 A1
(43) Pub. Date: Dec. 25, 2008

(54) Position Transducer

(76) Inventors: Mark Dodgson, Denbighshire (GB); Kenneth Hall, Wiltshire (GB)

Correspondence Address: CHARLES N. QUINN;FOX ROTHSCHILD LLP, 2000 MARKET STREET, 10TH FLOOR, PHILADELPHIA, PA, 19103, US

(21) Appl. No.: 11/795,103

(22) PCT Filed: Sep. 30, 2005
(86) PCT No.: PCT/GB05/03788

§ 371 Date: Aug. 14, 2008

(30) Foreign Application Priority Data
Jan. 12, 2005 (GB) 0500530.1

(51) Int. Cl. G06F 3/045

(52) U.S. Cl. 178/18.05

(57) ABSTRACT

A position transducer having first and second spaced apart resistive surfaces (22, 24), the first resistive surface (22) being connected to a first pair of spaced apart and substantially parallel electrodes (14) and the second resistive surface (24) being connected to a second pair of spaced apart and substantially parallel electrodes (16) orientated at substantially right angles to the first pair of electrodes, wherein at least one of the resistive surfaces is capable of being bent to touch the other surface such that current can flow from one of the first pair electrodes to one of the second pair electrodes via the resistive surfaces.

The present invention relates to position transducers, and in particular to position transducers for determining the position of a stylus in an x-y plane.

Position transducers are known in the field of sensing, robotics and automation. It is often necessary to determine the position of an object so that further movement / control inputs or adjustments can be made to that object for achieving desired operational outputs.

Known position transducers include amongst others;

linear variable differential transducers (LVDTs), which compare the magnetic coupling of a movable ferrite core in relation to a pair of oppositely wound coils; and

linear potentiometers, which provide a voltage output proportional to the linear displacement of a stylus along a resistive strip.

LVDTs are highly accurate, but suffer the disadvantage of being bulky, complex and comprising a number of parts, which need to be carefully assembled if they are to function as desired and a relatively high driving current is required to operate an LVDT, which is disadvantageous.

A linear potentiometer is less complex, but suffers the disadvantages of low accuracy compared to other devices and poor reproducibility of outputs. Linear potentiometers are also susceptible to wear (caused by contact abrasion), which resulting decreases in accuracy and/or functionality.

A further problem with known position transducers is that they are not capable of providing a composite x-y position output, requiring instead, independent sensors for determining the x and y coordinates of an object.

A known x-y position transducer is a touch sensitive display screen, which comprises a conductive backing film, a separator layer and a conducting covering. Touching the covering causes it to contact backing film, enabling an electrical current to flow, whose value is characteristic of the position of the point of contact. Such systems are expensive due to the complexity of the arrangement of parts and require relatively complex calibration circuitry to obtain useful x-y position information.

The present invention aims to provide an improved position transducer. The present invention also aims to overcome one or more of the above problems.

Accordingly, a first aspect of the invention provides a position transducer comprising first and second spaced-apart resistive surfaces, the first resistive surface being connected to a first pair of spaced apart and substantially parallel electrodes and the second resistive surface being connected to second pair of spaced apart and substantially parallel electrodes oriented at substantially right angles to the first pair of electrodes, wherein at least one of the resistive surfaces can be bent to touch the other surface such that a current can flow from one of the first pair electrodes to one of the second pair electrodes via the resistive surfaces.

The first and second resistive surfaces are preferably disposed on a flexible backing sheet. The flexible backing sheet can be of any suitable type, although it is envisaged that a flexible polymer will be used for reasons of ease of manufacture, cost, weight and/or durability.

The layer of electrically resistive material may comprise a carbon-based layer, such as a carbon doped polymer film. Any other electrically resistive material may be used, including a partially conducting polymer layer.

The electrodes are preferably formed as copper tracks or conducting ink (e.g. screen printed silver ink) on a backing sheet, i.e. the flexible backing sheet. The electrodes are preferably located on the backing sheet and the resistive surfaces overlaid to form electrical contacts between the electrodes and edges (either physical or electrical) of the resistive sheet.

The flexible sheet, where provided is preferably provided with two discrete areas of resistive material and is arranged to fold along a fold line such that the layers of resistive material are arranged face each other. One or more spacers are preferably provided around the periphery of one or both resistive surfaces to create the spaced-apart relationship.

A second aspect of this invention provides a method of determining the contact point of first and second spaced apart resistive surfaces, at least one of which has been bent towards the other to form a contact comprising the steps of;

Injecting an electrical current at an edge of the first resistive surface and detecting the current at a transverse edge of the second resistive surface whilst maintaining a high impendence between the transverse edge and the opposite edge of the second resistive surface; and

Reading the detected current off a lookup table to determine the position of the contact point relative to the edge of the first resistive surface into which the current was injected.

Preferably, the method is repeated by injecting an electrical current at an edge of the second resistive surface and detecting the current at a transverse edge of the first resistive surface whilst maintaining a high impendence between the transverse edge and the opposite edge of the first resistive surface; and

Reading the detected current off a lookup table to determine the position of the contact point relative to the edge of the second resistive surface into which the current was injected.

Preferably, the method is repeated at regular intervals and most preferably, the method is repeated alternatively for the currents injected into the first and second resistive sheets to yield the coordinates of the contact point relative to the edges of the resistive surfaces. Where measurements are taken at intervals, they are preferably taken many times per second.

The edges of the resistive surfaces can be their actual physical edges or a pseudo-electrical edge determined by the position of an electrode.

The electrodes are preferably addressed independently via wires. The wires can be formed as copper tracks formed integrally with the electrodes. A connector is preferably provided to connect the wires or tracks to external circuitry.

A circuit may be provided to operate the transducer and or the measurement method.

Electrical currents are preferably injected by connecting an electrode to a power supply, e.g. a battery. The currents are preferably detected by connecting an electrode to a detector circuit. The detector circuit may comprise one of more amplifiers, which are most preferably current amplifiers.

A circuit may also be provided comprising a ROM circuit that stores a lookup table for the transducer. A microprocessor is preferably provided to carrying out a comparison between the detected current and values stored in the lookup table. The microprocessor may then provide an output signal in response to the result of the comparison. The output signal may be an analogue signal, such as a voltage proportional to the position of the contact point relative to the edge of the resistive surface or a digital signal that can be processed to give either a reading (e.g. on a screen or dial) or used to control another device.

A preferred embodiment of the invention shall now be described, by way of example only, with reference to the accompanying drawings, in which;

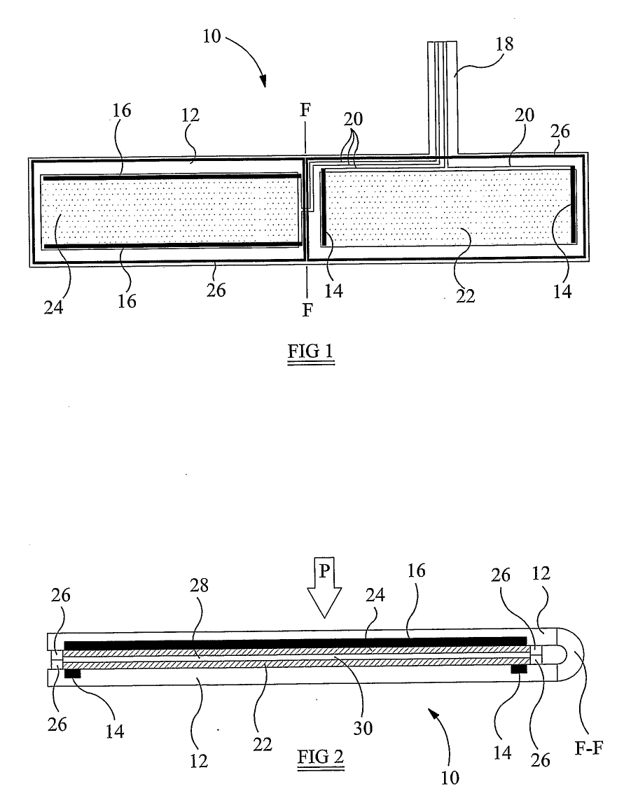

FIG. 1 shows a plan view of the transducer in an unfolded state;

FIG. 2 shows a schematic cross-section through the transducer in a folded state;

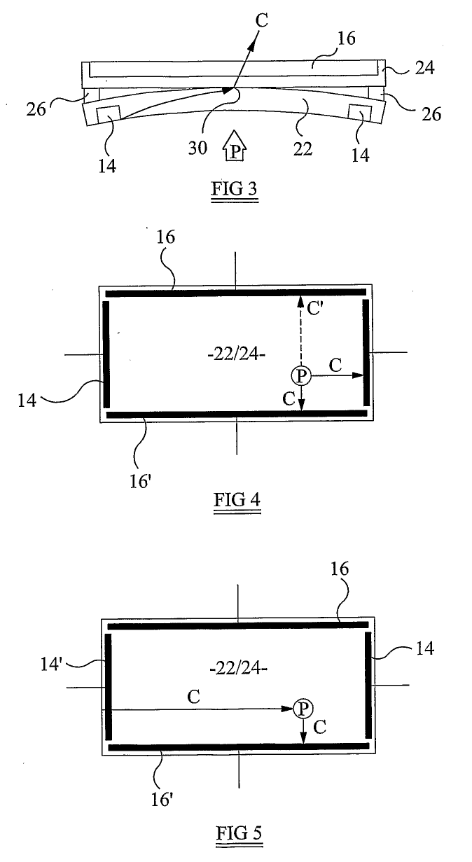

FIG. 3 shows a partial schematic cross-section through the transducer in use; and

FIGS. 4 and 5 shows how the transducer is electrically connected in use to ascertain the position of point P.

Referring now to FIG. 1, a transducer 10 is shown comprising a flexible polymer backing sheet 12 onto which pairs of copper x 14 and y 16 electrodes are deposited. The x 14 and y 16 electrodes are connected to a wiring tab 18 via copper tracks 20 that are also deposited onto the flexible backing sheet 12. Conductive carbon pads 22 & 24 are deposited onto the flexible backing sheet 12 partially overlying the electrode pairs 14 & 16. Spacers 26 are provided around each carbon pad 22 & 24 located near the periphery of the flexible backing sheet 12. The electrodes 14 & 16 can be addressed individually via connections made to the tracks 20 at the end of the wiring tab 18. The flexible backing sheet 12 has a line of weakness (not shown) such that it can be folded along line F-F such that the carbon pads 22 & 24 face each other.

FIG. 2 shows a schematic cross section of the transducer when folded. As can be seen, the flexible backing sheet 12 is folded about F-F such that the spacers 26 contact each other. The spacers 26 are provided with self-adhesive surfaces (not shown) such that once folded, it becomes difficult to unfold the flexible backing sheet 12. The carbon pads 22 & 24 are separated by the spacers 26 to leave a gap 28 therebetween. Electrical signals can be applied to desired electrodes 14 & 16 and monitored. When a compressive force is applied to either side of the transducer 10, e.g. as indicated by arrow P (the pressure point), the flexible backing sheet 12 will tend to bend thereby closing the gap 28 in the vicinity of the pressure point. When the carbon pads 22 & 24 touch 30 electrical currents will be transmitted between the electrode pairs 14 & 16 thereby changing the electrical equilibrium of the transducer. That change can be detected using a circuit and interpreted in such a way that the location of the pressure point P can be ascertained.

Because there are two electrode pairs 14 & 16, the position of P with respect to the x electrodes 14 and y electrodes 16 can be ascertained, thereby providing an x-y coordinate of pressure point P with respect to a datum point of the transducer 10.

In use, the transducer 10 is operated as follows:

Referring to FIG. 3 of the drawings, a partial schematic section through the transducer 10 is shown. A voltage is applied to electrodes 14′ that causes a voltage gradient across the x-plate 22. The contact point P causes the gradient to be divided by diverting current through the y-plate 24 to the second. y-electrode 16. Thus, by changing the position of the contact point P the potential gradient can be divided differently.

FIG. 4 shows the reverse whereby a voltage is applied to electrodes 16′ to create a potential gradient across the y-plate 24. The conduction paths are indicated schematically by arrows C.

In principle, the transducer 10 works by creating a potential divider across the carbon ink of the x plate 22 or the y plate 24. The contacts 14 & 16 are disposed at the ends of the x plate 22 and the y plate 24.

When the x-plate 22 is being measured, it is connected to a low impedance power source, which develops a voltage gradient across the plate. Also, at the same time, the y plate electrodes 16 are disconnected from their power source. The y plate 24 is used as the return path for the stylus signal P from the x-plate 22.

Because the resistance of the return path will change depending on the stylus position across the pad, one end of the y-plate 24 is connected to a high impedance voltage follower, which has an impedance several orders of magnitude higher than the impedance of the plates 22 & 24. In this way the current and hence impedance of the y plate 24 return path becomes highly insignificant or irrelevant.

Another advantage of the technique of the invention is that the cycling of the power applied to the pads 22 & 24 effectively self-checks the pad 22 & 24 and connections 14 & 16. The output of the voltage follower is connected to an analogue-to-digital converter (ADC) in the processor, which samples the voltages. The x and y plates 22 & 24 have field-effect-transistor switches connected to the ends 14 & 16 which are used to disconnect the low impedance power from the plates 22 & 24.

Software in the processor connects the power in sequence to the plates 22 & 24 so the ADC will read the sequence of returned voltages.

By using a microprocessor, the transducer can be used to measure the position of point P in addition to being able to self-check itself. For example:
1. Disconnecting all power from both plates 22 & 24 reads the last reading, which checks for leakage or shorts.
2. Disconnecting the x-plate and applying a positive potential with no ground to the y-plate should give a positive voltage reading on the x-plate. Thus checks for a positive connection and continuity via the x-plate.
3. Connecting ground with no positive to the y plate gives a ground reading on the x-plate. This checks the ground connection and continuity via the x-plate.
4. Connecting a positive and ground gives a reading of the stylus' y-position on the x-plate. This checks for a positive connection and continuity via x-plate.
5. Disconnecting the y-plate and connecting a positive voltage with no ground to the x-plate gives a positive reading on the y-plate.
6. Connecting ground with no positive voltage to the x plate gives a ground reading on the y-plate
7. Connecting a positive voltage and ground to the y-plate gives the x-position of the stylus on the y-plate

As can be seen, the invention differs significantly from the conventional approach for unidirectional soft pots, which use separate layers for x and y measurements each having separate contact tails or wires. Advantageously, by folding using a folding device (as per the invention) it is possible to manufacture a combination x-y transducer from a single sheet of single sided material, which the connection arrangement and materials costs considerably cheaper.

The measurement steps of FIGS. 3 and 4 are alternated on a periodic basis thereby enabling the position of P to be constantly monitored. It is envisaged that the measurements of FIGS. 3 and 4 could be repeated many times per second, thereby enabling almost real-time measurement of the position of point P.

The transducer is initially calibrated by moving point P at 1 mm increments in the x & y directions and the currents measured. The currents are then tabulated for the know x & y positions for each test of FIG. 3 and 4. That calibration table is then used as the lookup table for subsequent measurements.

The lookup table is preferably stored in a ROM microchip associated with the circuit for controlling the transducer.

The transducer can be recalibrated in accordance with a servicing regime, if desired; to take into account factors such as wear and/or changes in operating conditions.

It is envisaged that the invention will find application in the syringe driver art for detecting the position and or alignment of the syringe plunger by providing a stylus associated with the syringe body or plunger arranged to contact the transducer.

1-27. (canceled)

28: A composite x-y position transducer comprising first and second spaced apart resistive surfaces disposed on a single flexible backing sheet that is folded such that the areas of resistance are arranged to face one another, the first resistive surface being connected to a pair of spaced apart and substantially parallel electrodes and the second resistive surface being connected to a second pair of spaced apart and substantially parallel electrodes orientated at substantially right angles to the first pair of electrodes, wherein at least one of the resistive surfaces can be bent to contact the other surface such that current can flow from one of the first pair electrodes to one of the second pair electrodes via the resistive surfaces and wherein the electrodes are addressed independently via wires connected to external circuitry.

29: A position transducer as claimed in claim 28 wherein the flexible backing sheet is a flexible polymer.

30: A position transducer as claimed in claim 29 wherein the layer of electrically resistive material on the backing sheet is a carbon-based layer.

31: A position transducer as claimed in claim 30 wherein the carbon-based layer is a carbon doped polymer film.

32: A position transducer as claimed in claim 31 wherein the electrodes are formed as copper tracks or conducting ink on the backing sheet.

33: A position transducer as claimed in claim 32 wherein the electrodes are located on the backing sheet and the resistive surfaces overlaid to form electrical contacts between the electrodes and edges of the resistive sheet.

34: A position transducer as claimed in claim 33 wherein one or more spacers are provided around the periphery of one or both resistive surfaces to create the spaced apart relationship.

35: A position transducer as claimed in claim 34 wherein the electrodes are addressed independently via wires.

36: A position transducer as claimed in claim 35 wherein the wires are formed as copper tracks formed integrally with the electrodes.

37: A position transducer as claimed in claim 36 wherein a connector is provided to connect the wires to external circuitry.

38: A position transducer as claimed in claim 37 further comprising a circuit to operate the transducer.

39: A position transducer as claimed in claim 38 wherein electrical currents are injected by connecting an electrode to a power supply.

40: A position transducer as claimed in claim 39 wherein an electrode is connected to a detector circuit for detection of the currents.

41: A position transducer as claimed in claim 40 wherein the detector circuit comprises one or more amplifiers.

42: A position transducer as claimed in claim 41 wherein a ROM circuit is provided for storing a look-up table for the transducer.

43: A position transducer as claimed in claim 42 wherein a microprocessor is provided for carrying out a comparison between current detected and values stored in the lookup table.

44: A method of determining the contact point of first and second spaced apart resistive surfaces, at least one of which has been bent towards the other to form a contact, the method comprising the steps of:
injecting an electrical current at an edge of the first resistive surface and detecting the current at a transverse edge of the second resistive surface whilst maintaining a high impendence between the transverse edge and the opposite edge of the second resistive surface;
reading the detected current off a lookup table to determine the position of the contact point relative to the edge of the first resistive surface into which the current was injected;
injecting an electrical current at an edge of the second resistive surface and detecting the current at a transverse edge of the first resistive surface whilst maintaining a high impendence between the transverse edge and the opposite edge of the first resistive surface; and
reading the detected current off a look up table to determine the position of the contact point relative to the edge of the second resistive surface into which the current was injected.

45: A method according to claim 44 wherein the steps are repeated at regular intervals.

46: A method according to claim 45 wherein the steps are repeated alternatively for the currents injected into the first and second resistive sheets to yield the coordinates of the contact point relative to the edges of the resistive surfaces.

47: A method according to claim 46 wherein the edges of the resistive surfaces comprise their actual physical edges.

48: A method according to claim 47 wherein the edges of the resistive surfaces are pseudo-electrical edges determined by the positioning of an electrode.

49: A method according to claim 48 further comprising addressing the electrodes independently via wires.

50: A method according to claim 49 further comprising connecting the wires to external circuitry.

51: A method according to claim 50 further comprising injecting the electrical currents by connecting an electrode to a power supply.
